(19) United States
(12) Patent Application Publication
(10) Pub. No.: US 2010/0070916 A1
(43) Pub. Date: Mar. 18, 2010

(54) Template skimming preview

(75) Inventors: Aaron Shane Montgomery Lees, Vancouver (CA); Stella Du, Vancouver (CA)

Correspondence Address: PVF -- APPLE INC.;c/o PARK, VAUGHAN & FLEMING LLP, 2820 FIFTH STREET, DAVIS, CA, 95618-7759, US

(73) Assignee: Apple Inc., Cupertino, CA (US)

(21) Appl. No.: 12/284,218

(22) Filed: Sep. 18, 2008

(51) Int. Cl. G06F 3/048

(52) U.S. Cl. 715/801; 715/859; 715/802

(57) ABSTRACT

Some embodiments of the present invention provide a system that facilitates selection of a template for a document by a user. During operation, the system displays a graphical object associated with the template to the user and detects a position of a cursor over the graphical object. Next, in response to a cursor movement over the graphical object, the system displays a set of template previews for the template within the graphical object.

### BACKGROUND

1. Field of the Invention

The present invention relates to techniques for facilitating selection of a template for a document by a user.

2. Related Art

Templates are typically used for creating documents from a pre-specified design, pattern, or style. In particular, templates may include predefined layouts, formatting, graphics, and/or other elements that allow users to create documents. For example, templates may be used to provide page layout design patterns for documents such as signs, brochures, catalogs, and/or presentations.

User selection of templates is generally facilitated by displaying thumbnails or icons representing the templates to the user. The user may then open a template by selecting the icon or thumbnail corresponding to the template. For example, the user may open the template by double-clicking on the icon or thumbnail using a mouse, touchpad, and/or other pointing device, or by pressing a combination of keys on a keyboard. However, current template selection mechanisms typically do not provide previewing capabilities beyond a single image for each template. As a result, document creation from a template may be hindered or delayed by the user's inability to preview multiple pages or components of the template prior to selecting of the template.

### SUMMARY

Some embodiments of the present invention provide a system that facilitates selection of a template for a document by a user. During operation, the system displays a graphical object associated with the template to the user and detects a position of a cursor over the graphical object. Next, in response to a cursor movement over the graphical object, the system displays a set of template previews for the template within the graphical object.

In some embodiments, the system also establishes a focus on the graphical object by the cursor prior to displaying the template previews.

In some embodiments, the focus is based on a period of time spent over the graphical object by the cursor or a location of the cursor over the graphical object.

In some embodiments, the system also resizes the graphical object based on input from the user.

In some embodiments, the template previews represent template elements from the template.

In some embodiments, displaying the template previews within the graphical object involves displaying the template previews in an order that is based on a direction of the cursor movement.

In some embodiments, the displaying of the template previews within the graphical object is stopped when the cursor exits the graphical object.

In some embodiments, the graphical object is at least one of a thumbnail, an icon, and an image.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows a computing device in accordance with an embodiment of the present invention.

FIG. 2A shows an exemplary screenshot in accordance with an embodiment of the present invention.

FIG. 2B shows an exemplary screenshot in accordance with an embodiment of the present invention.

FIG. 2C shows an exemplary screenshot in accordance with an embodiment of the present invention.

FIG. 2D shows an exemplary screenshot in accordance with an embodiment of the present invention.

FIG. 2E shows an exemplary screenshot in accordance with an embodiment of the present invention.

FIG. 2F shows an exemplary screenshot in accordance with an embodiment of the present invention.

FIG. 2G shows an exemplary screenshot in accordance with an embodiment of the present invention.

FIG. 3 shows a flowchart illustrating the process of facilitating selection of a template for a document by a user in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

Embodiments of the invention provide a method and system for facilitating user selection of a template. The template may be used to create a document such as a newsletter, poster, flyer, resume, report, brochure, and/or presentation. More specifically, embodiments of the invention provide a method and system for previewing the template within a graphical object associated with the template. The graphical object may correspond to a thumbnail, icon, and/or image of one or more template elements within the template.

Furthermore, a set of template previews representing other template elements may be displayed within the graphical object upon detecting a cursor position over the graphical object. The template previews may additionally be displayed in an order that is based on a direction of the cursor's movement over the graphical object. Finally, the display of the template previews may be stopped upon exiting the graphical object by the cursor.

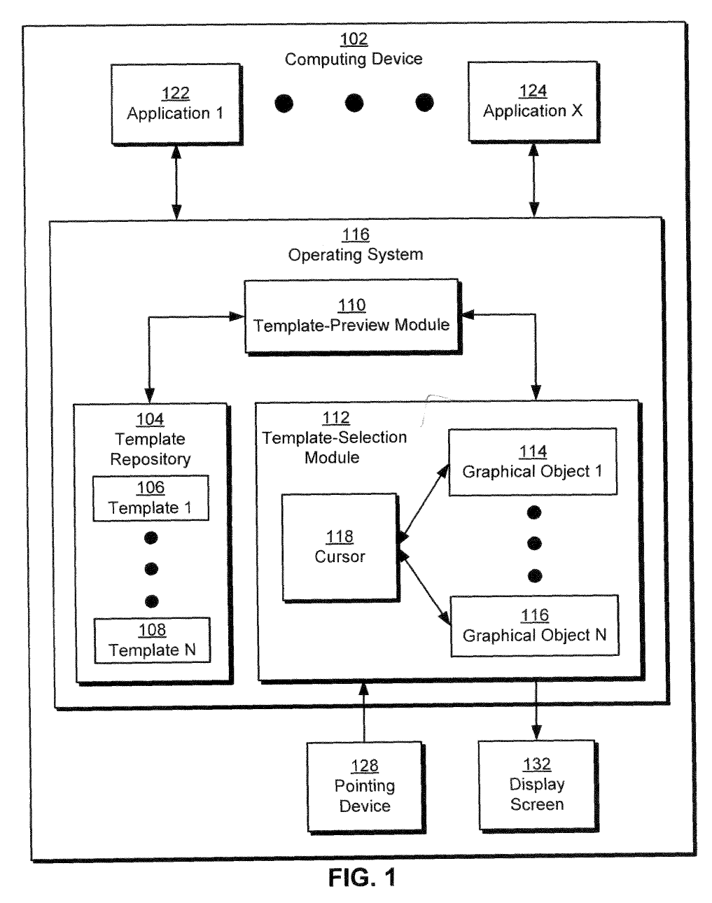

FIG. 1 shows a computing device 102 in accordance with an embodiment of the present invention. As shown in FIG. 1, computing device 102 includes multiple applications (e.g., application 1 122, application x 124), an operating system 116, a pointing device 128, and a display screen 132. Each of these components is described in further detail below.

Computing device 102 may correspond to an electronic device that provides one or more services or functions to a user. For example, computing device 102 may operate as a mobile phone, personal computer, global positioning system (GPS) receiver, portable media player, personal digital assistant (PDA), and/or graphing calculator. In addition, computing device 102 may include an operating system 116 that coordinates the use of hardware and software resources on computing device 102, as well as one or more applications (e.g., application 1 122, application x 124) that perform specialized tasks for the user. For example, computing device 102 may include applications (e.g., application 1 122, application x 124) such as an email client, an address book, a document editor, a tax preparation application, a web browser, and/or a media player. To perform tasks for the user, applications (e.g., application 1 122, application x 124) may obtain the use of hardware resources (e.g., processor, memory, I/O components, wireless transmitter, etc.) on computing device 102 from operating system 116, as well as interact with the user through a hardware and/or software framework provided by operating system 116, as described below.

To enable interaction with the user, computing device 102 may include one or more hardware input/output (I/O) components, such as pointing device 128 and display screen 132. Each hardware I/O component may additionally be associated with a software driver (not shown) that allows operating system 116 and/or applications on computing device 102 to access and use the hardware I/O components.

Display screen 132 may be used to display images and/or text to one or more users of computing device 102. In one or more embodiments of the invention, display screen 132 serves as the primary hardware output component for computing device 102. For example, display screen 132 may allow the user(s) to view menus, icons, windows, emails, websites, videos, pictures, maps, documents, and/or other components of a user interface (not shown) provided by operating system 116. Those skilled in the art will appreciate that display screen 132 may incorporate various types of display technology to render and display images. For example, display screen 132 may be a liquid crystal display (LCD), an organic light-emitting diode (OLED) display, a surface-conducting electron-emitter display (SED), and/or other type of electronic display.

Pointing device 128 may function as a hardware input component of computing device 102. Specifically, pointing device 128 may allow the user to point to and/or select one or more areas of display screen 132 using a cursor 118, highlight, and/or other visual indicator provided by the user interface. Input entered by the user using pointing device 128 may be processed by the corresponding software driver and sent to operating system 116 and/or one or more applications (e.g., application 1 122, application x 124) as one or more actions. In one or more embodiments of the invention, pointing device 128 may be a mouse, a touch pad, a finger or a stylus on a touch-sensitive display, a trackball, a pointing stick, and/or a joystick.

Those skilled in the art will appreciate that other input devices (not shown) may exist on computing device 102. For example, computing device 102 may also include a keyboard, webcam, remote control, and/or one or more sets of device-specific buttons. Operating system 116 and/or the application(s) (e.g., application 1 122, application x 124) may use the input from the input device(s) to perform one or more tasks, as well as update the user interface in response. Images corresponding to the user interface may be sent by operating system 116 to a screen driver, which may display the images on display screen 132 as a series of pixels. As a result, the user may interact with computing device 102 by using pointing device 128 and/or other input devices to provide input to operating system 116 and/or applications and receiving output from operating system 116 and/or applications through display screen 132.

In one or more embodiments of the invention, computing device 102 includes functionality to facilitate the user's selection of templates for use in one or more applications. The templates may be associated with and used to create posters, flyers, reports, brochures, presentations, resumes, and/or other page-oriented documents. As a result, the templates may be provided by and selected within applications such as word processors, spreadsheets, presentation programs, and/or other components of an office suite.

More specifically, a template-preview module 110 within operating system 116 may allow the user to preview a set of templates (e.g., template 1 106, template n 108) provided by the application(s). The templates may be stored in a template repository 104 that is accessible to template-preview module 110. Alternatively, templates for each application (e.g., applications in an office suite) may be provided to template-preview module 110 by the application in lieu of being stored in a centralized repository. Furthermore, the templates may be used to generate graphical objects (e.g., graphical object 1 114, graphical object n 116) within a template-selection module 112 for previewing by the user via a cursor 118, keyboard, and/or other input mechanism.

In one or more embodiments of the invention, graphical objects within template-selection module 112 correspond to thumbnails, icons, and/or images representing the templates in template repository 104. Consequently, each graphical object may include a visual representation of one page, portion, and/or element of a corresponding template within template repository 104. However, the user may be unable to adequately preview a template using a single image, icon, or thumbnail representing the template. The lack of previewing capabilities may further preclude the user from efficiently selecting a template for a document. For example, the user may be required to open each template to view the contents of the template prior to selecting a template for use in the document.

To enable a more thorough preview of templates in template repository 104, template-preview module 110 may “skim” a set of template previews within one or more graphical objects in template-selection module 112 in response to cursor 118 movements over the graphical objects by the user. In particular, template-preview module 110 may first detect a position of cursor 118 over a graphical object. Template-preview module 110 may also establish a focus on the graphical object by cursor 118 based on a period of time spent over the graphical object by cursor 118 and/or a location of cursor 118 within the graphical object. Once the position and/or focus of cursor 118 on the graphical object are established, template-preview module 110 may display a set of template previews within the graphical object in response to a movement over the graphical object by cursor 118. After previewing templates within one or more graphical objects in template-selection module 112, the user may open or select a template for use in document creation by selecting the corresponding graphical object using cursor 118, a keyboard, and/or another input mechanism.

In one or more embodiments of the invention, template previews displayed within a graphical object represent template elements from a template corresponding to the graphical object. For example, each template preview may include template elements from a page or portion of the template. Furthermore, the graphical object may be updated with a new template preview upon detection of additional cursor 118 movements over the graphical object by template-preview module 110. As a result, the user may preview multiple pages and/or portions of a template by moving cursor 118 within a graphical object corresponding to the template in template-selection module 112. The display of template previews within the graphical object may also be stopped upon exiting the graphical object by cursor 118.

For example, a template for a catalog may include five different pages of template elements. One page (e.g., the first page) may be displayed within a graphical object in template-selection module 112 as a visual representation of the template upon initializing template-selection module 112 within computing device 102. However, if a cursor 118 position and/or focus on the graphical object is established, additional cursor 118 movements within the graphical object may cause the other pages of the template to be displayed within the graphical object. For example, the graphical object may be updated with a template preview of a different page upon detecting a new cursor 118 position within the graphical object.

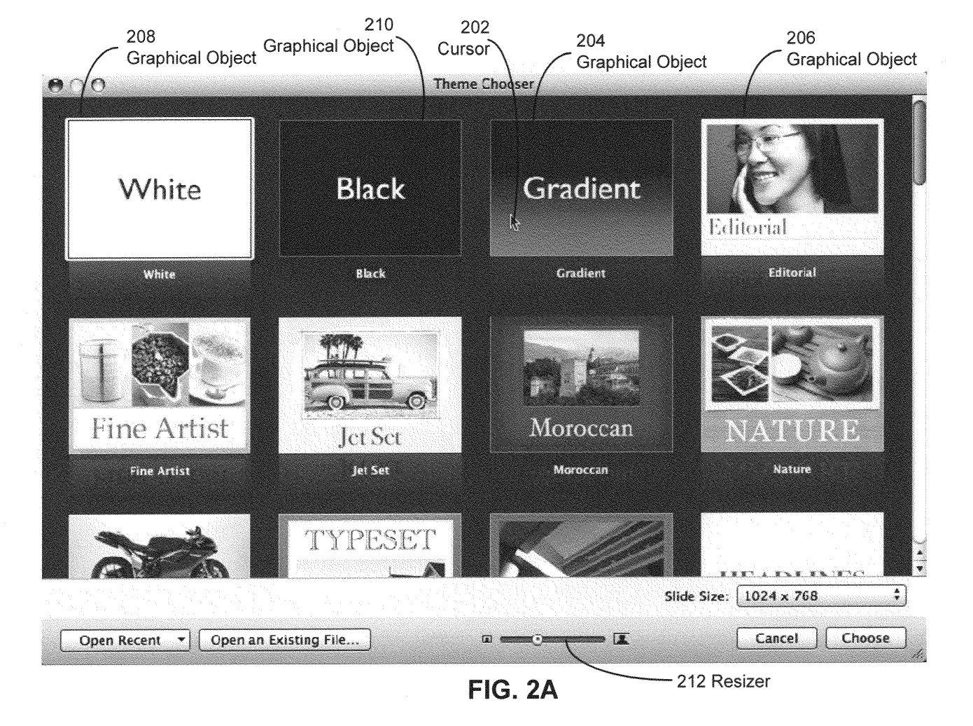

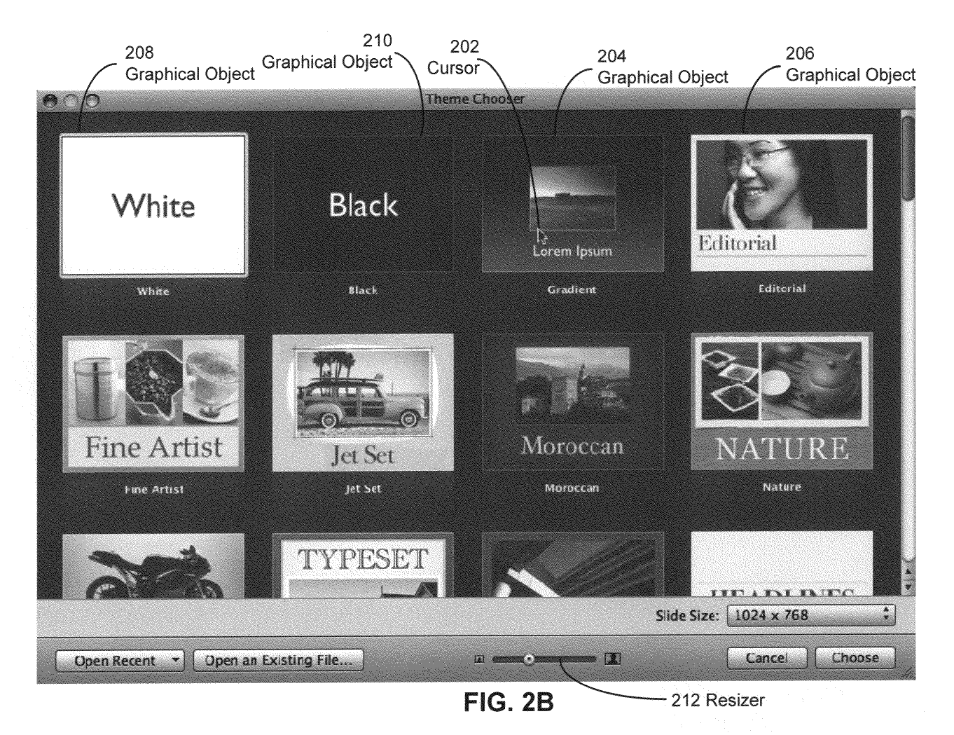

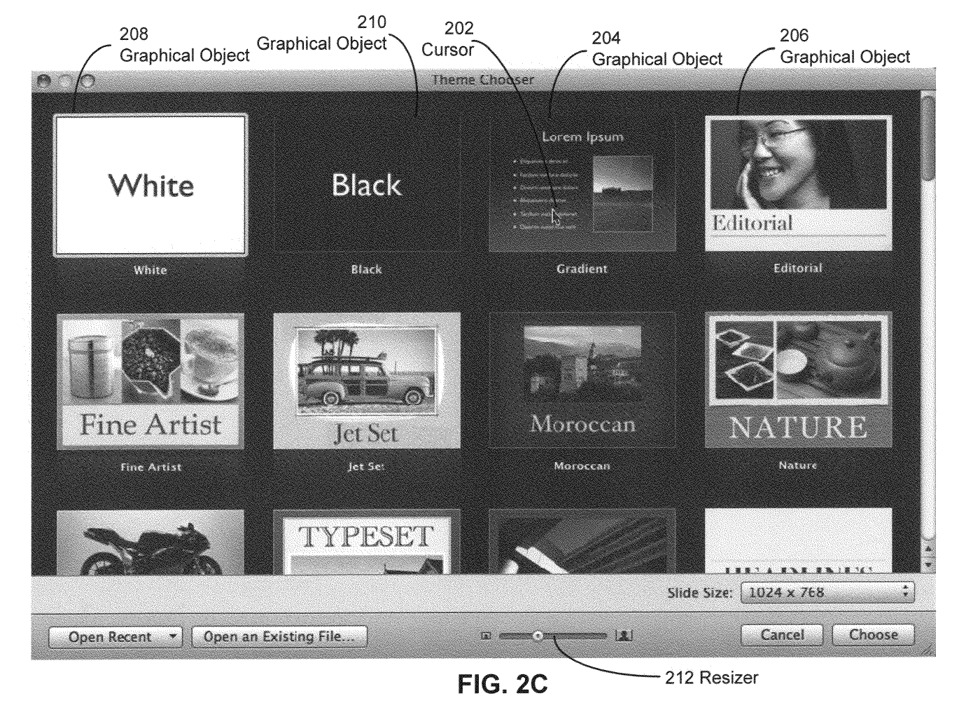

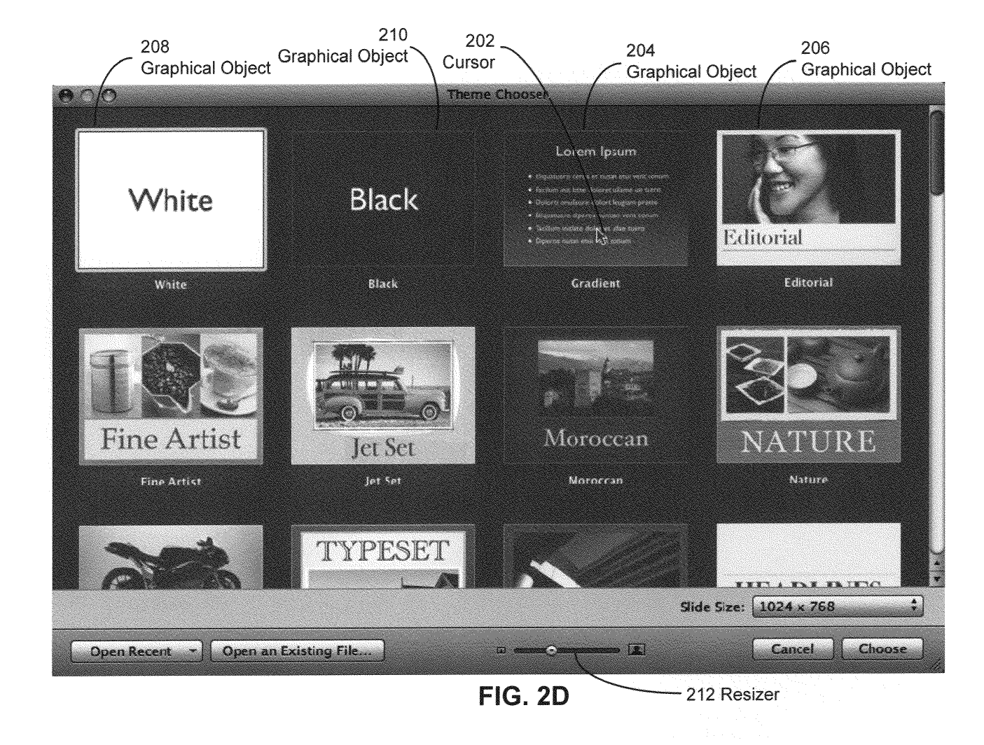

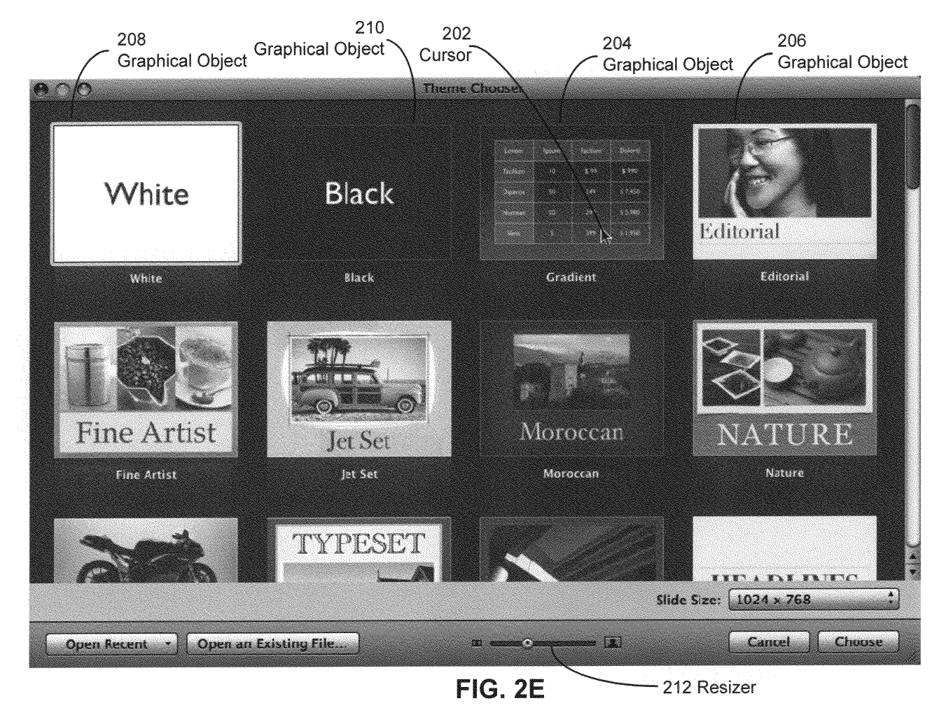

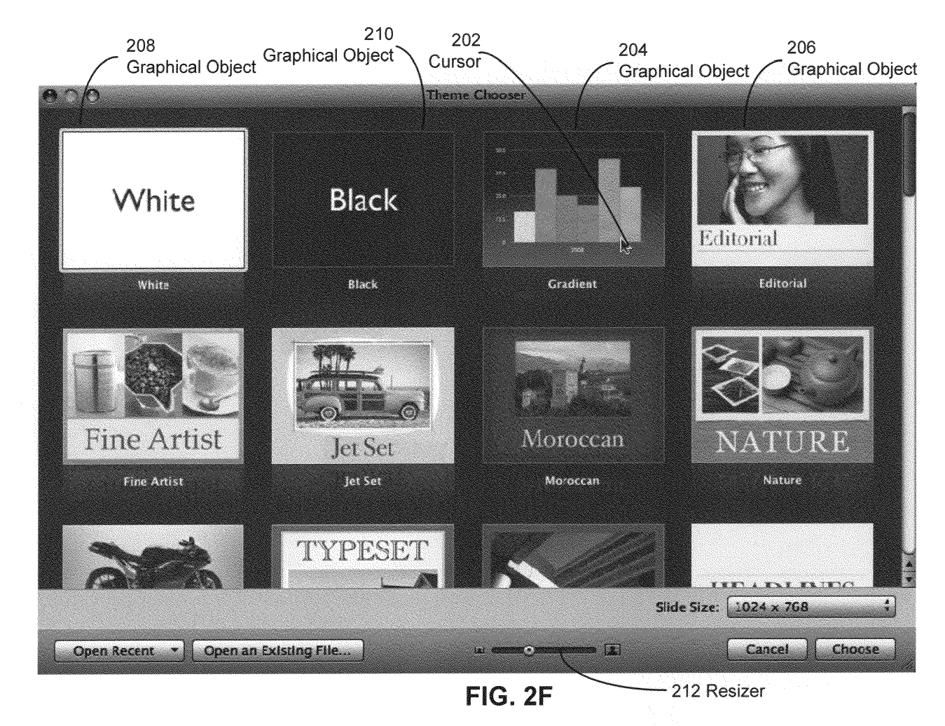

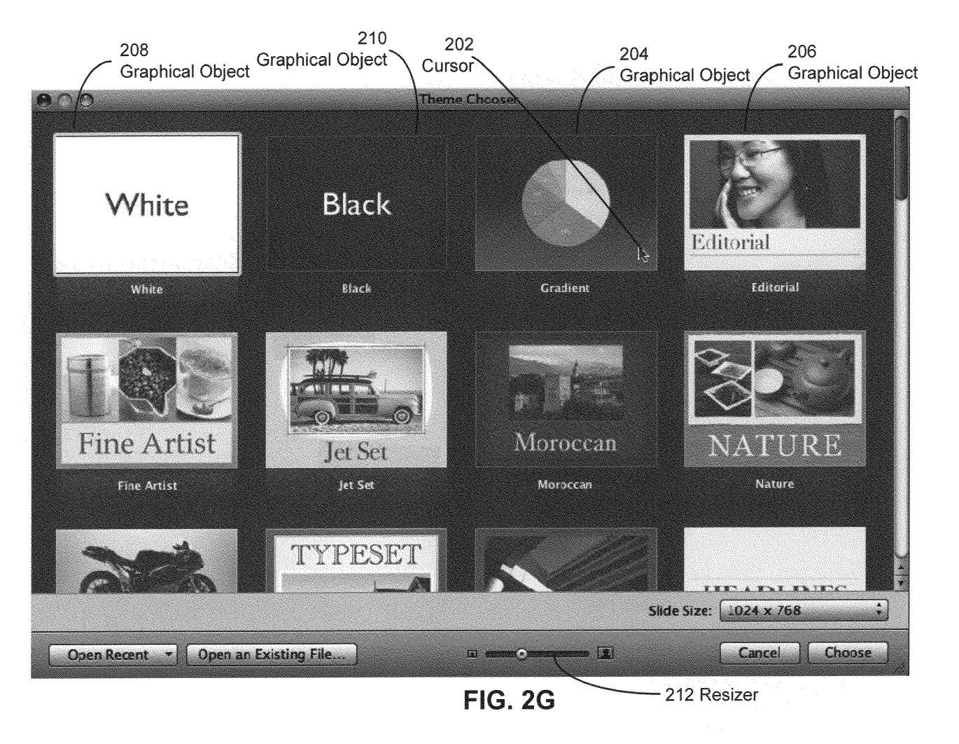

In one or more embodiments of the invention, the display of template previews within a graphical object is based on a direction of cursor 118 movement over the graphical object. For example, the template previews may be displayed in an order that is based on a horizontal and/or vertical direction of movement by cursor 118 over the graphical object. Alternatively, the template previews may be displayed in a particular order (e.g., from first page to last page) as cursor 118 moves in an initial direction within the graphical object. A reversal of the initial direction may cause a reversal of the display of template previews within the graphical object (e.g., from last page to first page). Display of template previews within a graphical object is discussed in further detail below with respect to FIGS. 2A-2G.

Moreover, computing device 102 may include functionality to resize graphical objects in template-selection module 112 based on input from the user. For example, the size of a graphical object may be increased to allow the user to view template elements within the graphical object at a higher resolution. On the other hand, the size of graphical objects within template-selection module 112 may be decreased to allow the user to view a larger set of graphical objects and/or template previews within a single window or user interface. As with user selection of templates, changes in the size of graphical objects may be specified by the user through cursor 118, a keyboard, and/or another input mechanism.

Those skilled in the art will appreciate that the generation and display of template previews within the graphical objects may be accomplished in a variety of ways. For example, template-preview module 110 may update a graphical object with a collection of thumbnails, icons, and/or images corresponding to the template previews in response to cursor 118 input from the user. The thumbnails, icons, and/or images may be stored in template repository 104 along with the templates, or stored in another repository that is accessible to template-preview module 110. Alternatively, template-preview module 110 may dynamically generate and display template previews directly from templates in template repository 104 in response to cursor 118 input over graphical objects in template-selection module 112 from the user.

FIG. 2A shows an exemplary screenshot in accordance with an embodiment of the present invention. More specifically, FIG. 2A shows a screenshot of a template-selection module, such as template-selection module 112 of FIG. 1. The template-selection module includes a cursor 202, a number of graphical objects 204-210, and a resizer 212. The components of FIG. 2A may facilitate selection of templates associated with graphical objects 204-210 by a user, as explained below.

As described above, graphical objects 204-210 may represent templates for documents such as posters, brochures, flyers, resumes, presentations, and/or catalogs. A user may select a template by clicking on the corresponding graphical object 204-210 using cursor 202, a combination of keyboard presses, and/or another input mechanism. The user may also preview template components beyond what is currently displayed in the corresponding graphical object 204-210 by positioning cursor 202 over the graphical object and moving cursor 202 within the graphical object. In response to the movement of cursor 202 within the graphical object, the graphical object may be updated with a set of template previews associated with the template.

As shown in FIG. 2A, cursor 202 is positioned over graphical object 204. Furthermore, graphical object 204 currently displays an image representing one or more elements of a corresponding template. However, a movement of cursor 202 within graphical object 204 may cause graphical object 204 to display, or “skim,” other elements of the template in the form of one or more template previews. The template previews may be provided by a template-preview module, such as template-preview module 110 of FIG. 1.

Those skilled in the art will appreciate that the template-preview module may skim template previews within graphical object 204 in a variety of ways. For example, template previews may be displayed immediately upon entering graphical object 204 by cursor 202. Alternatively, template previews for the template may not be displayed until a focus on graphical object 204 by cursor 202 has been established. For example, the display of template previews within graphical object 204 may be based on a period of time spent within graphical object 204 by cursor 202. Similarly, template preview displays may be triggered by a location of cursor 202 within graphical object 204 (e.g., a distance away from the center of graphical object 204).

The user may also update the size of graphical objects 204-210 using resizer 212. In particular, resizer 212 may correspond to a slider element that allows the user to increase or decrease the sizes of graphical objects 204-210 within the template-selection module. Moving the slider to the right may cause graphical objects 204-210 to increase in size, while moving the slider to the left may cause graphical objects 204-210 to decrease in size. Resizer 212 may thus be used to view graphical objects 204-210 and/or associated template previews at a higher resolution, or to view more graphical objects at once within the template-selection module. The template-selection module may also allow individual graphical objects to be resized independently of other graphical objects shown to the user.

FIG. 2B shows an exemplary screenshot in accordance with an embodiment of the present invention. More specifically, FIG. 2B shows the template-selection module of FIG. 2A after a movement of cursor 202 to the right has taken place within graphical object 204. As a result, graphical object 204 is updated to display a template preview that is different from that of FIG. 2A. In other words, the repositioning of cursor 202 over graphical object 204 has triggered the display of template previews within graphical object 204.

As mentioned previously, the template previews may be displayed in an order that is based on the direction of movement by cursor 202 within graphical object 204. In other words, the template preview shown within graphical object 204 may be based on the rightward motion of cursor 202. For example, a leftward motion of cursor 202 from the position of cursor 202 in FIG. 2A may preclude template previews from displaying within graphical object 204, since a leftward motion may cause cursor 202 to exit graphical object 204 or to leave an area of focus within graphical object 204. Additional changes to the position of cursor 202 may also produce template preview displays that are based on the direction of change, as discussed below.

FIG. 2C shows an exemplary screenshot in accordance with an embodiment of the present invention. In particular, FIG. 2C shows the template-selection module of FIG. 2B after an additional rightward movement of cursor 202 within graphical object 204. Graphical object 204 is now updated with a template preview that is different from that of FIGS. 2A and 2B. In other words, the rightward motion of cursor 202 within graphical object 204 may cause a continual display of template previews within graphical object 204 in a pre-specified order. For example, template previews within graphical object 204 may progress through various (e.g., from first to last) pages of the corresponding template until cursor 202 exits graphical object 204.

Moreover, changes in the direction of movement by cursor 202 may cause the order of display to change. For example, a leftward motion of cursor 202 may trigger a display of the template preview of FIG. 2B within graphical object 204. Vertical movements by cursor 202 may also produce a progression or regression of template preview displays within graphical object 204, or no effect on the display of template previews. For example, a downward motion of cursor 202 may cause the next page of the template to be previewed within graphical object 204, while an upward motion of cursor 202 may cause the previous page (e.g., as shown in FIG. 2B) of the template to be previewed within graphical object 204.

FIG. 2D shows an exemplary screenshot in accordance with an embodiment of the present invention. The screenshot of FIG. 2D shows the template-selection module of FIG. 2C after an additional rightward movement of cursor 202 within graphical object 204. As a result, cursor 202 is now positioned close to the horizontal center of graphical object 204. Furthermore, graphical object 204 shows a template preview that is next in order based on the continuing rightward motion of cursor 202. As a result, the template preview within graphical object 204 of FIG. 2D is different from those of FIGS. 2A-2C.

FIG. 2E shows an exemplary screenshot in accordance with an embodiment of the present invention. The screenshot of FIG. 2E corresponds to the template-selection module of FIG. 2D after cursor 202 is moved further to the right within graphical object 204. Graphical object 204 is also updated with a template preview based on the movement of cursor 202 from the location shown in FIG. 2D to the location shown in FIG. 2E. Furthermore, a reversal (i.e., leftward motion) in the movement of cursor 202 may cause graphical object 204 to update with previously displayed template previews, such as those of FIGS. 2A-2D.

FIG. 2F shows an exemplary screenshot in accordance with an embodiment of the present invention. FIG. 2F shows a continuation in the display of template previews within graphical object 204 based on the rightward movement of cursor 202. In other words, FIG. 2F shows a template preview within graphical object 204 that is next in order from the template preview of FIG. 2E. Furthermore, changes in the direction of cursor 202 may cause changes to the order of the display of template previews, as described previously.

FIG. 2G shows an exemplary screenshot in accordance with an embodiment of the present invention. In particular, FIG. 2G shows a final template preview within graphical object 204 that is triggered by another rightward movement of cursor 202 within graphical object 204. As shown in FIG. 2G, cursor 202 is positioned close to the right edge of graphical object 204. As a result, additional rightward movements of cursor 202 may cause cursor 202 to exit graphical object 204 or an area of focus within graphical object 204, thus resetting or stopping the display of template previews within graphical object 204. For example, graphical object 204 may revert to displaying the image shown in FIG. 2A upon exiting of graphical object 204 by cursor 202. However, leftward movement of cursor 202 may cause the template previews to progress in the reverse order of that shown in FIGS. 2A-2G. Consequently, the user may “skim” back and forth through template previews within graphical objects 204-210 by moving cursor 202 in one or more directions within a particular graphical object. Furthermore, the user may resize the graphical objects using resizer 212, as described above.

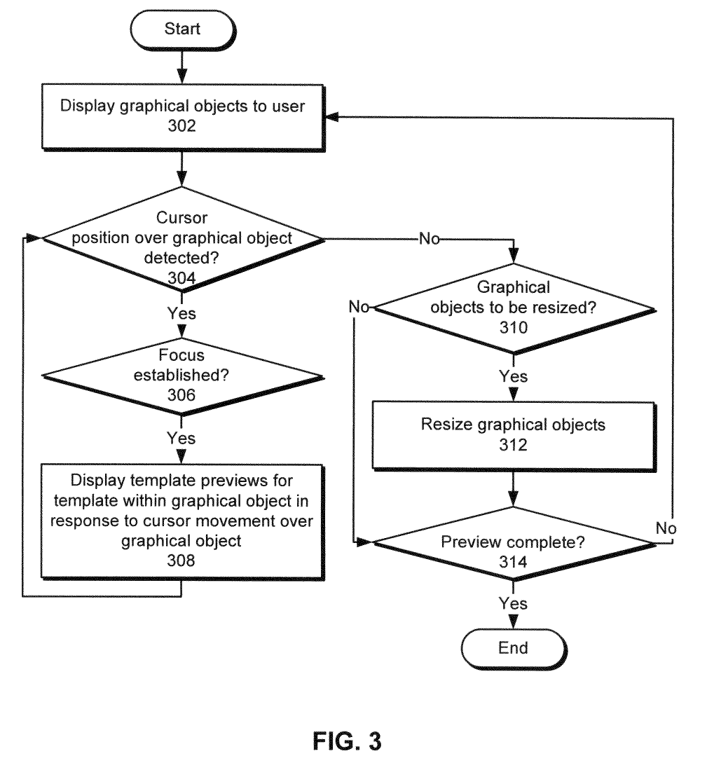

FIG. 3 shows a flowchart illustrating the process of facilitating selection of a template for a document by a user in accordance with an embodiment of the present invention. In one or more embodiments of the invention, one or more of the steps may be omitted, repeated, and/or performed in a different order. Accordingly, the specific arrangement of steps shown in FIG. 3 should not be construed as limiting the scope of the invention.

Initially, a set of graphical objects is displayed to a user (operation 302). The graphical objects may be displayed within a template-selection module, such as template-selection module 112 of FIG. 1. The graphical objects may further correspond to and represent templates that may be used in document creation by the user. For example, the templates may be used by the user to create resumes, reports, brochures, catalogs, letters, and/or presentations.

The user may also view a set of template previews within each graphical object by “skimming” the template previews using cursor movements over the graphical object. To begin previewing a template associated with a graphical object, a cursor position over the graphical object may be detected (operation 304). In addition, a focus on the graphical object by the cursor may be established (operation 304) after detecting the cursor position over the graphical object. The focus may be based on a period of time spent over the graphical object by the cursor and/or a location of the cursor within the graphical object. As a result, the focus may prevent template previews from triggering in situations such as passing through the graphical object as the cursor is moved to a different area of the screen.

If both cursor position and focus are established for the graphical object, a set of template previews for the corresponding template are displayed within the graphical object in response to cursor movements over the graphical object (operation 308). As mentioned above, the display of template previews may be based on a direction of the cursor movement. Similarly, template previews within the graphical object may be stopped if the cursor is no longer within the graphical object and/or has exited an area of focus within the graphical object.

Independently of cursor position and/or template previewing, the user may resize the graphical objects (operation 310). For example, the user may use a slider element within the template-selection module to increase or decrease the size and resolution of one or more graphical objects within the template-selection module. Along the same lines, the user may resize the graphical object(s) using a touchpad or keyboard with zooming capabilities. If user input related to resizing is received, the graphical objects are resized (operation 312) based on input from the user.

Template previewing and resizing of graphical objects (operations 302-312) may continue until template previewing is complete (operation 314). For example, the user may discontinue template previewing by selecting a template for use in a document within the template-selection module, or the user may close the template-selection module without selecting a template.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for facilitating selection of a template for a document by a user, comprising:
displaying a graphical object associated with the template to the user;
detecting a position of a cursor over the graphical object; and
in response to a cursor movement over the graphical object, displaying a set of template previews for the template within the graphical object.

2. The method of claim 1, further comprising:
establishing a focus on the graphical object by the cursor prior to displaying the template previews.

3. The method of claim 2, wherein the focus is based on at least one of a period of time spent over the graphical object by the cursor and a location of the cursor over the graphical object.

4. The method of claim 1, further comprising:
resizing the graphical object based on input from the user.

5. The method of claim 1, wherein the template previews represent template elements from the template.

6. The method of claim 1, wherein displaying the template previews within the graphical object involves displaying the template previews in an order that is based on a direction of the cursor movement.

7. The method of claim 1, wherein the displaying of the template previews within the graphical object is stopped upon exiting the graphical object by the cursor.

8. The method of claim 1, wherein the graphical object is at least one of a thumbnail, an icon, and an image.

9. A system for facilitating selection of a template for a document by a user, comprising:
a template repository comprising a set of templates;
a template-selection module, comprising:
a cursor; and
a set of graphical objects associated with the templates; and
a template-preview module configured to:
detect a position of the cursor over a graphical object from the graphical objects; and
in response to a cursor movement over the graphical object, display a set of template previews for a corresponding template within the graphical object.

10. The system of claim 9, wherein the template-preview module is further configured to:
establish a focus on the graphical object by the cursor prior to displaying the template previews within the graphical object.

11. The system of claim 10, wherein the focus is based on at least one of a period of time spent over the graphical object by the cursor and a location of the cursor over the graphical object.

12. The system of claim 9, wherein the template-preview module is further configured to:
resize the graphical object based on input from the user.

13. The system of claim 9, wherein the template previews represent template elements from the template.

14. The system of claim 9, wherein displaying the template previews within the graphical object involves displaying the template previews in an order that is based on a direction of the cursor movement.

15. The system of claim 9, wherein the displaying of the template previews within the graphical object is stopped upon exiting the graphical object by the cursor.

16. The system of claim 9, wherein the graphical object is at least one of a thumbnail, an icon, and an image.

17. A computer-readable storage medium storing instructions that when executed by a computer cause the computer to perform a method for facilitating selection of a template for a document by a user, the method comprising:
displaying a graphical object associated with the template to the user;
detecting a position of a cursor over the graphical object; and
in response to a cursor movement over the graphical object, displaying a set of template previews for the template within the graphical object.

18. The computer-readable storage medium of claim 17, the method further comprising:
establishing a focus on the graphical object by the cursor prior to displaying the template previews within the graphical object.

19. The computer-readable storage medium of claim 18, wherein the focus is based on at least one of a period of time spent over the graphical object by the cursor and a location of the cursor over the graphical object.

20. The computer-readable storage medium of claim 17, the method further comprising:
resizing the graphical object based on input from the user.

21. The computer-readable storage medium of claim 17, wherein the template previews represent template elements from the template.

22. The computer-readable storage medium of claim 17, wherein displaying the template previews within the graphical object involves displaying the template previews in an order that is based on a direction of the cursor movement.

23. The computer-readable storage medium of claim 17, wherein the displaying of the template previews within the graphical object is stopped upon exiting the graphical object by the cursor.

24. The computer-readable storage medium of claim 17, wherein the graphical object is at least one of a thumbnail, an icon, and an image.
